(19) United States
(12) Patent Application Publication
(10) Pub. No.: US 2009/0231581 A1
(43) Pub. Date: Sep. 17, 2009

(54) Turbidity sensor and electric home appliance having the same

(75) Inventors: Jeong Su Han, Suwon-si (KR); Sang Yeon Pyo, Suwon-si (KR); Hyen Young Choi, Suwon-si (KR); Sung Hoon Kim, Suwon-si (KR); Seong Joo Han, Yongin-si (KR); Su Ho Jc, Seongnam-si (KR); Sang Jun Lee, Suwon-si (KR); So Jung Yu, Suwon-si (KR); O. Do Ryu, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 12/222,116

(22) Filed: Aug. 1, 2008

(30) Foreign Application Priority Data
Mar. 14, 2008 (KR) 10-2008-0023856

(51) Int. Cl. G01N 21/51

(52) U.S. Cl. 356/341

(57) ABSTRACT

Disclosed are a turbidity sensor, which correctly senses a turbidity of water although the surface of the turbidity sensor is covered with foreign substances, such as scale, and an electric home appliance having the turbidity sensor. The turbidity sensor includes a light emitting part emitting light, a first light receiving part receiving light emitted from the light emitting part and travelling straight, a second light receiving part receiving light emitted from the light emitting part and scattered, and a control unit determining a turbidity of water according to a ratio of the amounts of the light received by the plurality of light receiving parts. The first light receiving part is installed in a direction of directly receiving the light emitted from the light emitting part, and the second light receiving part is installed in another direction of not directly receiving the light emitted from the light emitting part.

### CROSS-REFERENCE TO RELATED APPLICATIONS

This application claims the benefit of Korean Patent Application No. 2008-0023856, filed Mar. 14, 2008, in the Korean Intellectual Property Office, the disclosure of which is incorporated herein by reference.

### BACKGROUND

1. Field

The present invention relates to a turbidity sensor and an electric home appliance having the same, and more particularly, to a turbidity sensor, which correctly senses the turbidity of water although the surface of the turbidity sensor is covered with foreign substances, such as scale, and an electric home appliance having the turbidity sensor.

2. Description of the Related Art

Some products among electric home appliances using water, such as washing machines, dishwashers, etc., have a turbidity sensor installed therein to measure the turbidity, i.e., pollution level of water, and change a washing operation according to the sensed turbidity. These electric home appliances change a washing frequency according to the turbidity sensed by the turbidity sensor, thus reducing waste of water and carrying out the optimum washing operation.

As shown in FIGS. 1A and 1B, a conventional turbidity sensor 3 for a container 1 includes one light emitting part 3a, which emits light, and one light receiving part 3b, which receives the light emitted from the light emitting part 3a, and measures a turbidity of the water using the intensity of the light emitted from the light emitting part 3a and the intensity of the light received by the light receiving part 3b.

That is, when the light emitting part 3a emits light at a designated intensity, the light receiving part 3b receives the remainder of the light except for a portion of the light, which is scattered by particles floating in water, thus measuring the turbidity of the water. Here, the measured turbidity (f) is obtained by the Equation 1 below.

f(turbidity)=α×(amount of light received by light receiving part/amount of light emitted from light emitting part) [Equation 1]

Here, a is a proportional constant. The higher the turbidity of the water, the smaller the amount of the light emitted from the light emitting part 3a and the smaller the amount of the light received by the light receiving part 3b becomes. Thus, the smaller the obtained functional value of the Equation 1 becomes.

In the case that the turbidity of the water is high, as shown in FIG. 1A, a large amount of the light emitted from the light emitting part 3a is scattered by the particles in the water, and only a small amount of the light is received by the light receiving part 3b and thus the obtained functional value of Equation 1 is small. On the other hand, in the case that the turbidity of the water is low, as shown in FIG. 1B, a large amount of the light emitted from the light emitting part 3a passes through the water and is received by the light receiving part 3b and thus the obtained functional value of the Equation 1 is large. FIG. 2 shows a variation of the turbidity of the water according to a variation of the output of the turbidity sensor 3.

As shown in FIG. 2, the smaller the output of the turbidity sensor 3, the higher the turbidity of the water becomes (C), and the larger the output of the turbidity sensor 3, the lower the turbidity of the water becomes (D).

However, when the above conventional turbidity sensor 3 is used in a container 1 filled with water for a long time, the surface of the turbidity sensor 3 is covered with contaminants, such as scale. Consequently, the amount of light received by the light receiving part 3b is varied regardless of the turbidity of the water, and thus the turbidity sensor 3 may cause an error in measurement of the turbidity of the water. For example, even when the turbidity of the water is low, the amount of the light received by the light receiving part 3b is decreased due to the scale covering the surface of the light receiving part 3b and thus it may be determined that the turbidity of the water is high.

### SUMMARY

Therefore, one aspect of the embodiments is to provide a turbidity sensor, which correctly senses the turbidity of water although the surface of the turbidity sensor is covered with foreign substances, such as scale, due to use for a long time, and an electric home appliance having the turbidity sensor.

Another aspect of the embodiment is to provide a turbidity sensor, which correctly senses the turbidity of water in spite of any change in circumstances in addition to scale, and an electric home appliance having the turbidity sensor.

Additional aspects and/or advantages will be set forth in part in the description which follows and, in part, will be apparent from the description, or may be learned by practice of the invention.

The foregoing and/or other aspects are achieved by providing a turbidity sensor, including: a light emitting part emitting light; a plurality of light receiving parts receiving the light emitted from the light emitting part; and a control unit determining a turbidity of water according to a ratio of the amounts of the light received by the plurality of light receiving parts.

The plurality of light receiving parts may include a first light receiving part receiving light emitted from the light emitting part and travelling straight, and a second light receiving part receiving light emitted from the light emitting part and scattered.

The first light receiving part may be installed in a direction of directly receiving the light emitted from the light emitting part, and the second light receiving part may be installed in another direction of not directly receiving the light emitted from the light emitting part.

The second light receiving part may be installed at a position below the light emitting part and the first light receiving part in a direction approximately perpendicular to a straight line connecting the light emitting part and the first light receiving part.

The ratio of the amounts of the light may be a ratio of an amount of light received by the second light receiving part to an amount of light received by the first light receiving part.

The more the ratio of the amounts of the light may be increased in accordance with an increased level of turbidity of the water.

The plurality of light receiving parts may include a first light receiving part receiving light emitted from the light emitting part and travelling straight, and a plurality of second light receiving parts receiving light emitted from the light emitting part and scattered.

The ratio of the amounts of the light may be an average of a ratio of an amount of light received by any one of the plurality of second light receiving parts to the amount of light received by the first light receiving part and a ratio of an amount of light received by another of the plurality of second light receiving parts to an amount of light received by the first light receiving part.

The ratio of the amounts of the light may be a ratio of a sum of the amounts of light received by the plurality of second light receiving parts to the amount of light received by the first light receiving part.

The foregoing and/or other aspects are achieved by providing a turbidity sensor, including: a substrate having a light emitting part, and a first light receiving part receiving light emitted from the light emitting part and travelling straight, and a second light receiving part receiving light emitted from the light emitting part and scattered, and a control unit determining a turbidity of water according to a ratio of amounts of light received by the first and second light receiving parts installed on the substrate.

The second light receiving part may be installed halfway between the light emitting part and the first light receiving part.

The turbidity sensor may further include a cover covering the light emitting part and the first and second light receiving parts to prevent the light emitting part and the first and second light receiving parts from directly contacting water.

The foregoing and/or other aspects are achieved by providing a turbidity sensor used in an electric home appliance having a control unit controlling an operation of the appliance using a turbidity of water, including: a light emitting part emitting light; a plurality of light receiving parts receiving the light emitted from the light emitting part; and a circuit transmitting output values of amounts of light respectively received by the plurality of light receiving parts to the electric home appliance to determine the turbidity of the water according to a ratio of the amounts of light respectively received by the plurality of light receiving parts.

The foregoing and/or other aspects are achieved by providing an electric home appliance, including: a container configured to receive water; a turbidity sensor installed in the container and including a light emitting part emitting light, a plurality of light receiving parts receiving the light emitted from the light emitting part, and a control unit of the turbidity sensor determining turbidity of the water according to a ratio of amounts of light received by the light receiving parts and transmitting the turbidity of the water; and a control unit of the electric home appliance receiving the transmitted turbidity of the water from the control unit of the turbidity sensor and controlling an operation of the appliance according to the turbidity of the water.

The foregoing and/or other aspects are achieved by providing an electric home appliance, including: a container configured to receive water; a turbidity sensor installed in the container and including a light emitting part emitting light, a plurality of light receiving parts receiving the light emitted from the light emitting part, and a circuit transmitting the amounts of light respectively received by the plurality of light receiving parts; and a control unit determining turbidity of the water according to a ratio of the amounts of light respectively received by the light receiving parts and transmitted from the turbidity sensor, and controlling an operation of the appliance using the received turbidity of the water.

The electric home appliance may include a washing machine, a dishwasher, or a water purifier.

The foregoing and/or other aspects are achieved by providing a turbidity sensor for a dishwasher, including: a light emitting part emitting light in a forward direction through water; at least one first light receiving part disposed opposite the light emitting part and receiving the light emitted from the light emitting part in the forward direction; at least one second light receiving part receiving light deviating from a straight traveling path of the light emitted from the light emitting part; and a control unit determining a turbidity of the water according to a ratio of an amount of light received from the at least one first light receiving part to an amount of light received from the at least one second light receiving part.

The control unit of the turbidity sensor may transmit the determined turbidity to a control unit of the dishwasher, and the control unit of the dishwasher may cause the dishwasher to perform an operation of the dishwasher when the determined turbidity is greater than a reference turbidity and to terminate the operation of the dishwasher when the determined turbidity is less than or equal to the reference turbidity.

The foregoing and/or other aspects are achieved by providing a turbidity sensor, including: a light emitting part emitting light in a forward direction through water; at least one first light receiving part disposed opposite the light emitting part and receiving the light emitted from the light emitting part in the forward direction; at least two second light receiving parts receiving light deviating from a straight traveling path of the light emitted from the light emitting part; and a control unit determining a turbidity of the water according to an average value of a ratio of an amount of light received from the at least one first light receiving part to an amount of light received from at least one of the second light receiving parts and a ratio of the amount of light received from the at least one first light receiving part to an amount of light received from another of the second light receiving parts.

### BRIEF DESCRIPTION OF THE DRAWINGS

These and/or other aspects and advantages will become apparent and more readily appreciated from the following description of the embodiments, taken in conjunction with the accompanying drawings in which:

FIG. 1A is a conceptual view of a conventional turbidity sensor, in the case that turbidity is high;

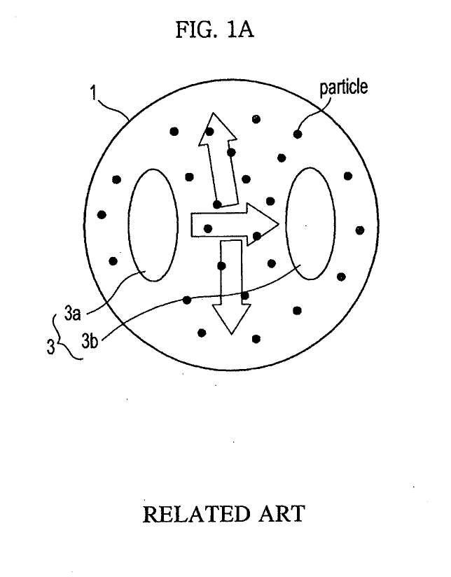

FIG. 1B is a conceptual view of the conventional turbidity sensor, in the case that turbidity is low;

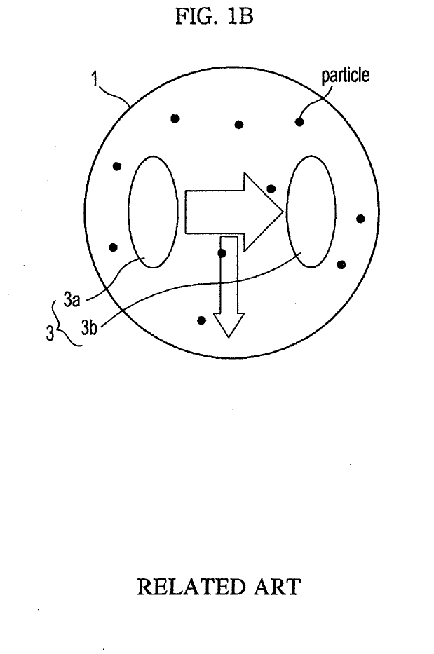

FIG. 2 is a graph illustrating an output wave form of the conventional turbidity sensor;

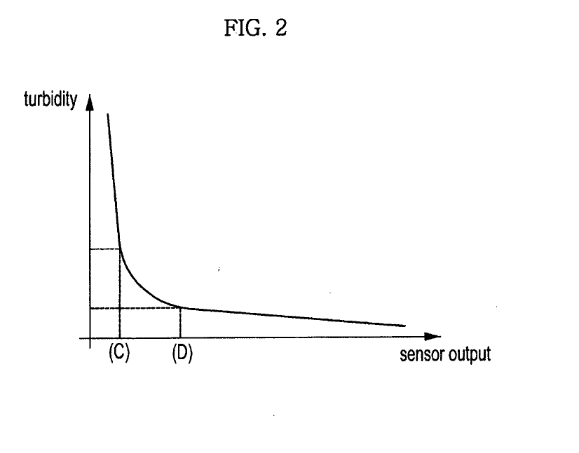

FIG. 3 is a view illustrating a structure of a turbidity sensor in accordance with a first embodiment;

FIG. 4A is a conceptual view of the turbidity sensor in accordance with the first embodiment, in the case that turbidity is high;

FIG. 4B is a conceptual view of the turbidity sensor in accordance with the first embodiment, in the case that turbidity is low;

FIG. 5 is a graph illustrating the output wave form of the turbidity sensor in accordance with the first embodiment;

FIG. 6 is a view illustrating the turbidity sensor of FIG. 4B, which is covered with scale;

FIG. 7 is a conceptual view of a turbidity sensor in accordance with a second embodiment;

FIG. 8 is a schematic view illustrating one example of the installation of the turbidity sensor in accordance with the first embodiment in a washing machine;

FIG. 9 is a schematic view illustrating another example of the installation of the turbidity sensor in accordance with the first embodiment in a washing machine;

FIG. 10 is a schematic view illustrating one example of the installation of the turbidity sensor in accordance with the first embodiment in a dishwasher;

FIG. 11 is a control block diagram of the dishwasher, in which the turbidity sensor in accordance with the first embodiment is installed; and

FIG. 12 is a flow chart illustrating a method of measuring turbidity in the dishwasher, in which the turbidity sensor in accordance with the first embodiment is installed.

### DETAILED DESCRIPTION OF EMBODIMENTS

Reference will now be made in detail to the embodiments, examples of which are illustrated in the accompanying drawings, wherein like reference numerals refer to like elements throughout. The embodiments are described below to explain the present invention by referring to the annexed drawings.

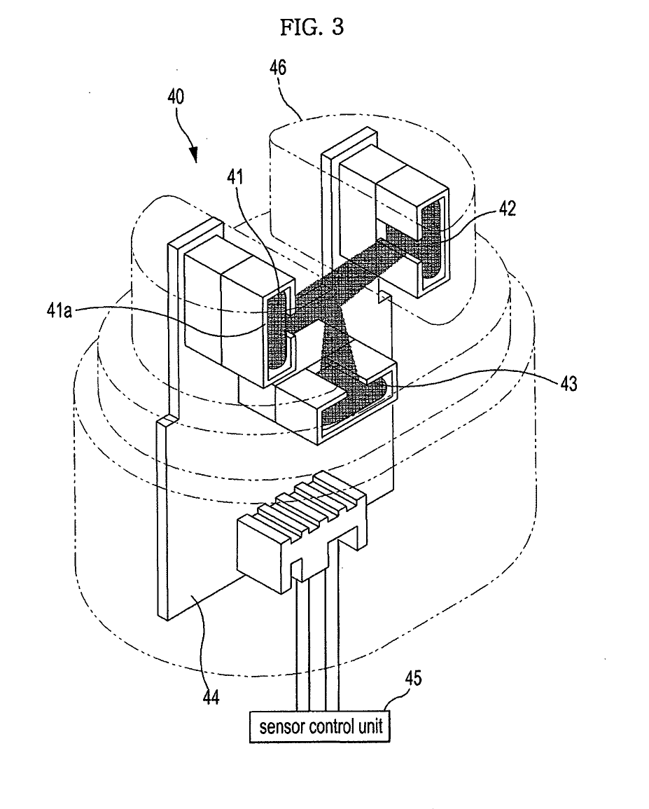

FIG. 3 is a view illustrating the structure of a turbidity sensor in accordance with a first embodiment.

In FIG. 3, a turbidity sensor 40 includes one light emitting part 41, which is installed on a substrate 44 and emits light, and first and second light receiving parts 42 and 43 respectively receiving the light emitted from the light emitting part 41. Generally, a light emitting element, such as an LED, for example, is used as the light emitting part 41, and light receiving elements, such as photo transistors or photo diodes, for example, are used as the first and second light receiving parts 42 and 43.

The light emitting part 41 is configured such that light can travel straight in a narrow range and is disposed in a case 41a. The first light receiving part 42 is disposed opposite to the light emitting part 41 so as to be located in the straight traveling range of the light emitted from the light emitting part 41, and the second light receiving part 43 is disposed at a position at which the second light receiving part 43 can receive scattering light that deviates from the straight traveling range of the light emitted from the light emitting part 41. Here, the second light receiving part 43 can be disposed at any position as far as the second light receiving part 43 receives only the scattering light that deviates from the straight traveling range of the light emitted from the light emitting part 41. However, in order to use a conventional cover 46 as it is, it is preferable that the second receiving part 43 is disposed on the substrate 44 at a position below the light emitting part 41 and the first light receiving part 42 in a direction approximately perpendicular to a straight line connecting the light emitting part 41 and the first light receiving part 42. The second receiving part 43 is installed halfway between the light emitting part 41 and the first receiving part 42.

The turbidity sensor 40 further includes a sensor control unit 45, which receives the amounts of light respectively received by the first and second light receiving parts 42 and 43, calculates a ratio of the amounts of light, and determines the turbidity of water using the ratio of the amounts of light.

Thus, when the light emitting part 41 emits light at a regular intensity, the first receiving part 42 receives a portion of the light, which passes through water in a container 30 and travels straight, and the second receiving part 43 receives the remainder of the light, which is scattered by particles contained in the water in the container 30. Then, the sensor control unit 45 receives the amounts of the portions of the light respectively received by the first and second light receiving parts 42 and 43, calculates a ratio of the amounts of the portions of the light, and determines the turbidity of the water using the ratio of the amounts of the portions of the light. Here, the measured turbidity (F) is obtained by the Equation 2 below.

F(turbidity)=α×(amount of light received by second light receiving part/amount of light received by the first light receiving part) [Equation 2]

Here, a is a proportional constant. The higher the turbidity of the water is, the larger than the amount of light scattered by the particles in the water is than the amount of light traveling straight from the light emitting part 41 to the first light receiving part 42. Thus, the amount of light received by the first light receiving part 42 is not larger than the amount of light received by the second light receiving part 43, and the output of the turbidity sensor 40 obtained by the Equation 2 is increased.

Further, the turbidity sensor 40 further includes a cover 46 covering the light emitting part 41 and the first and second light receiving parts 42 and 43 to prevent the light emitting part 41 and the first and second light receiving parts 42 and 43 from directly contacting the water.

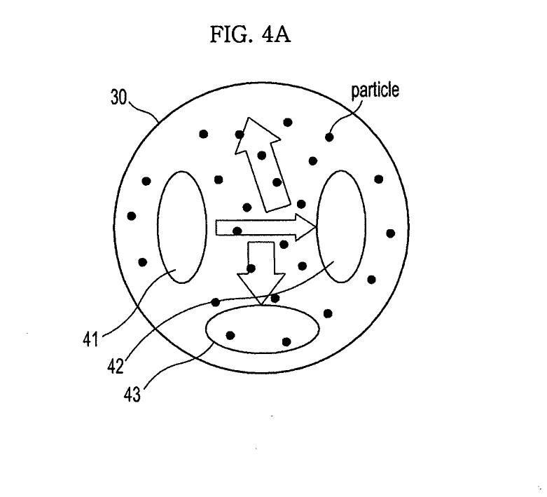

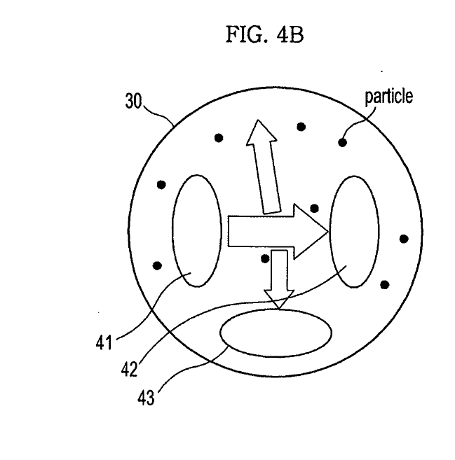

FIG. 4A is a conceptual view of the turbidity sensor in accordance with the first embodiment, in the case that the turbidity of the water is high, and FIG. 4B is a conceptual view of the turbidity sensor in accordance with the first embodiment, in the case that the turbidity of the water is low.

In the case that the turbidity of the water in the container 30 is high, as shown in FIG. 4A, the amount of light scattered by the particles in the water is larger than the amount of light traveling straight from the light emitting part 41 to the first light receiving part 42, and thus the amount of light received by the first light receiving part 42 is not larger than the amount of light received by the second light receiving part 43. Therefore, on the assumption that the amount of light received by the first receiving part 42 is 4 and the amount of light received by the second receiving part 43 is 6, for example, the turbidity (F) is calculated by the Equation 3 below.

F(turbidity)=α×(6/4)=1.5α [Equation 3]

On the other hand, in the case that the turbidity of the water in the container 30 is low, as shown in FIG. 4B, the amount of light traveling straight from the light emitting part 41 to the first light receiving part 42 is larger than the amount of light scattered by the particles in the water, and thus the amount of light received by the first light receiving part 42 is larger than the amount of light received by the second light receiving part 43. Therefore, on the assumption that the amount of light received by the first receiving part 42 is 8 and the amount of light received by the second receiving part 43 is 2, for example, the turbidity (F) is calculated by the Equation 4 below.

F(turbidity)=α×(2/8)=0.25α [Equation 4]

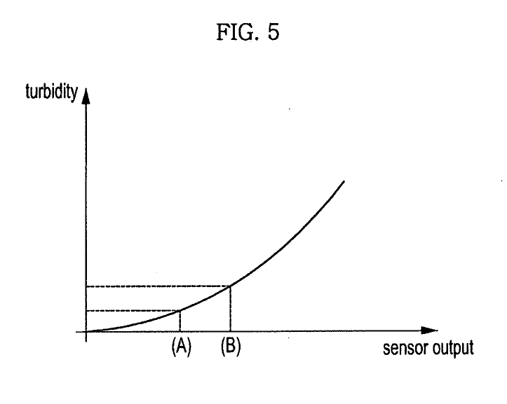

Therefore, in the case that the turbidity of the water in the container 30 is high, as shown in FIG. 4A, a large amount of the light emitted from the light emitting part 41 is scattered by the particles in the water, and only a small amount of the light is received by the first light receiving part 42 and thus the obtained functional value is large, as shown in the Equation 3. On the other hand, in the case that the turbidity of the water in the container 30 is low, as shown in FIG. 4B, a large amount of the light emitted from the light emitting part 41 passes through the water and is received by the first light receiving part 42 and thus the obtained functional value is small, as shown in the Equation 4. FIG. 5 shows a variation of the turbidity of the water according to a variation of the output of the turbidity sensor 40.

As shown in FIG. 5, the smaller the output of the turbidity sensor 40, which is varied according to the ratio of the amounts of light respectively received by the first and second light receiving parts 42 and 43, the lower the turbidity of the water becomes (A), and the larger the output of the turbidity sensor 40, the higher the turbidity of the water becomes (B).

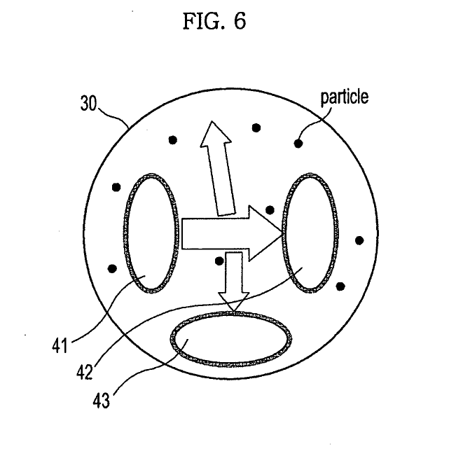

When the turbidity sensor 40 is used in water for a long time, the surface of the turbidity sensor 40 is covered with scale. It will be described with reference to FIG. 6. In this case, the amounts of light received by the first and second light receiving parts 42 and 43 are lowered due to foreign substances, such as scale, covering the surface of the turbidity sensor 40, regardless of the turbidity of the water.

FIG. 6 illustrates the turbidity sensor 40, which is covered with scale. It is supposed that the water in the container 30 of FIG. 4B and the water in the container 30 of FIG. 6 have the same turbidity. That is, FIG. 4B illustrates the turbidity sensor 40 before the turbidity sensor 40 is covered with scale, and FIG. 6 illustrates the turbidity sensor 40, which is covered with scale due to use for a long time.

Since the water in the containers 30 of FIGS. 4B and 6 have the same turbidity, the amounts of light traveling straight from the light emitting parts 41 to the first light receiving parts 42 of FIGS. 4B and 6 are the same and the amounts of light scattered by the particles in the water in the containers 30 of FIGS. 4B and 6 are the same. However, in FIG. 6, the surface of the turbidity sensor 40 is covered with scale, and thus the amounts of light received by the first and second light receiving parts 42 and 43 are reduced. But, when it is considered that the degrees of scale covering the surfaces of the first and second light receiving parts 42 and 43 in the same container 30 are regular, the reduced percentages of lights received by the first and second light receiving parts 42 and 43 are the same, and the turbidity of the water in the container in FIG. 6 is calculated by the Equation 5 below.

F(turbidity)=α×{(2−0.2)/(8−0.8)}=0.25 α [Equation 5]

Here, the reduced amounts (0.2 and 0.8) of light received by the first and second light receiving parts 42 and 43 represent degrees of the light of the first and second light receiving parts 42 and 43, which are reduced due to the scale. The amounts of light received by the first and second light receiving parts 42 and 43 are reduced by the same percentage (approximately 10%) due to the scale.

That is, since the scale caused by use for a long time has the same influence on the first and second light receiving parts 42 and 43, the turbidity sensor 40 of the present embodiment identically measures the turbidity of the water in the container 30 before and when the surface of the turbidity sensor 40 is covered with scale, and thus it is possible to prevent the malfunction of the turbidity sensor 40 due to the scale.

Further, the turbidity sensor 40 of the present embodiment correctly measures the turbidity of water under any change in circumstances, in addition to scale. For example, the turbidity sensor 40 correctly measures the turbidity of water under the power supply fluctuation of the light emitting part 41 and the aging of an LED forming the light emitting part 41.

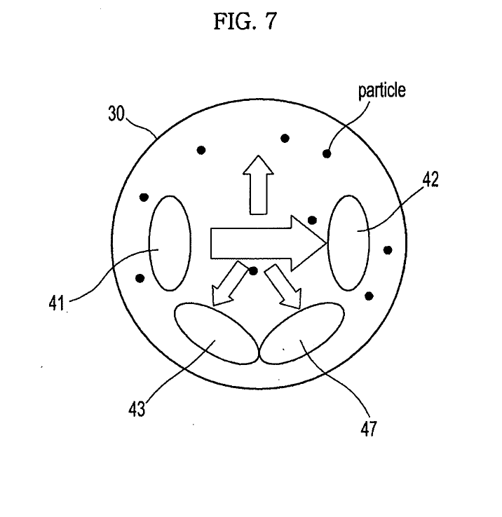

FIG. 7 is a conceptual view of a turbidity sensor in accordance with a second embodiment. Some parts of FIG. 7, which are substantially the same as those of FIG. 4B, are denoted by the same reference numerals even though they are depicted in different drawings, and a detailed description thereof will thus be omitted because it is considered to be unnecessary.

A turbidity sensor 40 of FIG. 7 further includes a third light receiving part 47, in addition to the components of the turbidity sensor 40 of FIG. 4B. That is, the turbidity sensor 40 includes three light receiving parts 42, 43, and 47.

In FIG. 7, the third light receiving part 47 is disposed at a position opposite to the second light receiving part 43 to receive a portion of light emitted from the light emitting part 41, which is scattered by particles in water. In order to use a conventional cover 46 as it is, the third light receiving part 47 may be disposed substantially in parallel with the second receiving part 43 on the substrate 44 below the light emitting part 41 and the first light receiving part 42.

Thus, when the light emitting part 41 emits light at a regular intensity, the first receiving part 42 receives a portion of the light, which passes through water in the container 30 and travels straight, and the second and third receiving parts 43 and 47 respectively receive the remainder of the light, which is scattered by particles contained in the water in the container 30. Then, in the second embodiment, the turbidity sensor 40 measures the turbidity of the water using a ratio of the amounts of light received by the first and second light receiving parts 42 and 43 and a ratio of the amounts of light received by the first and third light receiving parts 42 and 47.

For example, the amounts of light received by the first and second light receiving parts 42 and 43 and the amounts of light received by the first and third light receiving parts 42 and 47 are respectively measured and an average value is calculated, and then the turbidity of the water is measured using the average value. In this case, even if one of the second and third light receiving parts 43 and 47 may be out of order, the turbidity sensor 40 can still measure the turbidity of water.

Otherwise, a sum of the amount of light received by the second light receiving part 43 and the amount of light received by the third light receiving part 47 is divided by the amount of light received by the first light receiving part 42, and then the turbidity of the water is measured using the obtained value. In this case, the turbidity sensor 40 more sensitively and correctly measures a variation of scattering light, and thus more minutely measures the turbidity of water and improves the sensitivity and the correctness of the turbidity sensor 40.

When such a turbidity sensor 40 is used in water for a long time, the surface of the turbidity sensor 40 is covered with scale. In this case, since the amounts of light received by the first, second, and third light receiving parts 42, 43, and 47 are respectively lowered due to the scale covering the surface of the turbidity sensor 40, regardless of the turbidity of the water, the turbidity sensor 40 of the present embodiment identically measures the turbidity of the water in the container 30 before and when the surface of the turbidity sensor 40 is covered with scale.

In addition, alternatively, more than two light receiving parts may be disposed beneath the light emitting part and the first light receiving part to receive light scattered by particles contained in the water and more than one light receiving part may be disposed opposite the light emitting part. Further, more than one light emitting part may be included.

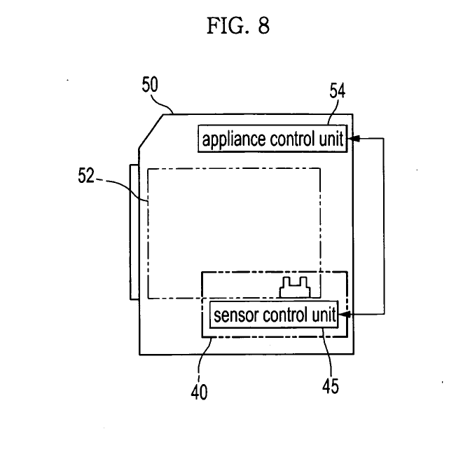

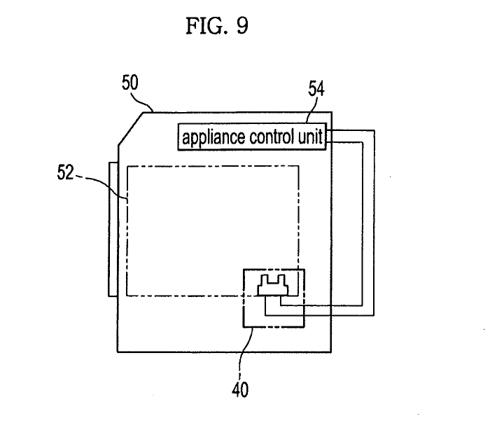

FIG. 8 is a schematic view illustrating one example of the installation of the turbidity sensor in accordance with the first embodiment in a washing machine, and FIG. 9 is a schematic view illustrating another example of the installation of the turbidity sensor in accordance with the first embodiment in a washing machine.

In FIGS. 8 and 9, a tub 52 containing water to perform a washing/rinsing operation is installed in a washing machine 50, a turbidity sensor 40 to measure the turbidity of the water contained in the tub 52 is installed in the lower portion of the tub 52, and an appliance control unit 54 to receive the turbidity measured by the turbidity sensor 40 and then change the washing/rinsing operation of the washing machine 50 is installed at a designated position in the washing machine 50.

The turbidity sensor 40 of FIG. 8 includes a sensor control unit 45 installed therein. The sensor control unit 45 measures a turbidity value using a ratio of the amounts of light received by the first and second light receiving parts 42 and 43, and transmits the measured turbidity value to the appliance control unit 54.

Then, the appliance control unit 54 of FIG. 8 receives the measured turbidity value from the sensor control unit 45 of the turbidity sensor 40, and additionally performs the washing/rinsing operation when the measured turbidity value is more than a reference turbidity, and terminates the washing/rinsing operation when the measured turbidity value is not more than the reference turbidity.

On the other hand, the turbidity sensor 40 of FIG. 9 does not have a sensor control unit 45, and thus includes a circuit, which transmits output values of the amounts of light respectively received by the first and second light receiving parts 42 and 43 to the machine control part 54.

Thus, the appliance control unit 54 of FIG. 9 directly receives the amounts of light respectively received by the first and second light receiving parts 42 and 43, calculates a ratio of the amounts of light, determines the turbidity of the water using the calculated ratio of the amounts of light, and additionally performs the washing/rinsing operation when the determined turbidity value is more than a reference turbidity, and terminates the washing/rinsing operation when the determined turbidity value is not more than the reference turbidity.

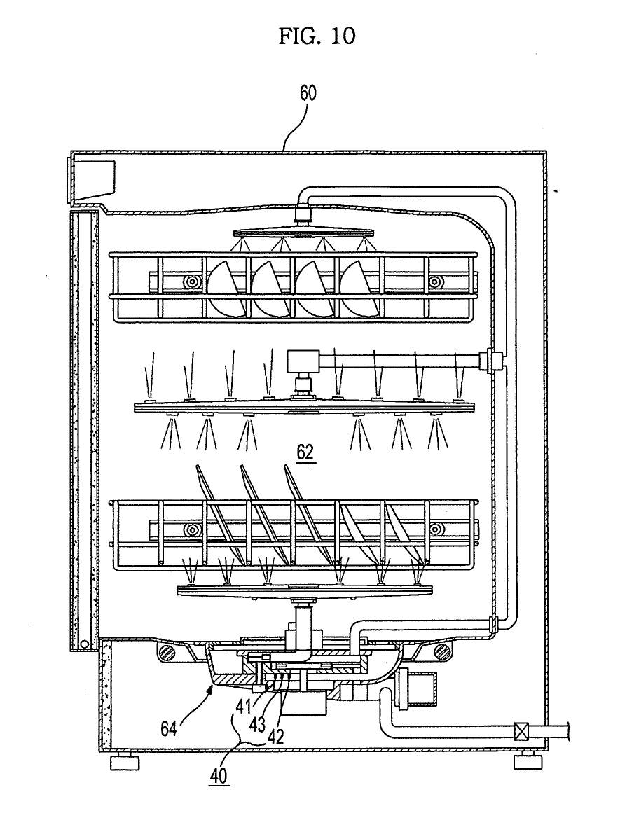

FIG. 10 is a schematic view illustrating one example of the installation of the turbidity sensor in accordance with the first embodiment in a dishwasher. The description of the whole structure of a dishwasher 60 will be omitted, and the structure of a portion of the dishwasher 60, in which a turbidity sensor 40 is installed, will be described in detail.

In FIG. 10, a washing tub 62 to perform a washing/rinsing operation is provided in the dishwasher 60, a sump 64 to collect water supplied to the inside of the washing tub 62 and pumping out the water is provided under the washing tub 62, and the turbidity sensor 40 to measure the turbidity of the water is installed in the sump 64.

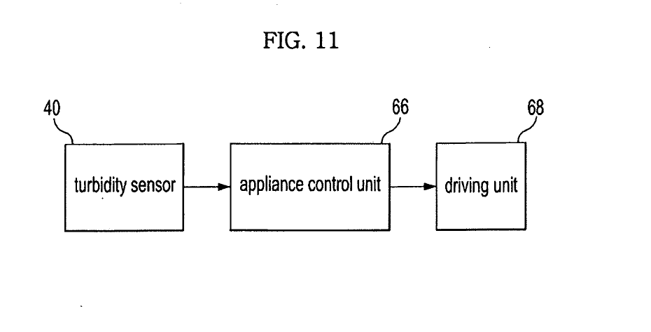

FIG. 11 is a control block diagram of the dishwasher, in which the turbidity sensor in accordance with the first embodiment is installed. The dishwasher 60 includes the turbidity sensor 40, an appliance control unit 66, and a driving unit 68.

The fundamental operation of the appliance control unit 66 in connection with the measurement of the turbidity by the turbidity sensor 40 is similar to that of the appliance control unit 54 of the washing machine 50 of FIGS. 8 or 9. However, the appliance control unit 66 of the dishwasher 60 has an algorithm, which is implemented to satisfy the operation of the dishwasher, and additionally performs a washing/rinsing operation when the measured turbidity is more than a reference turbidity, and terminates the washing/rinsing operation when the measured turbidity is not more than the reference turbidity, thus preventing waste of water and performing the optimum washing/rinsing operation.

That is, the appliance control unit 66 may receive the turbidity value measured by the sensor control unit 45 of the turbidity sensor 40 and then change the washing/rinsing operation. Alternately, the appliance control unit 66 may receive the amounts of light received by the first and second light receiving parts 42 and 43 of the turbidity sensor 40, calculate a ratio of the amounts of light, and then determine the turbidity of the water.

The driving unit 68 drives a load of the dishwasher 60 according to a driving control signal of the appliance control unit 66.

Hereinafter, the operations and functions of the above turbidity sensor and an electric home appliance having the same will be described.

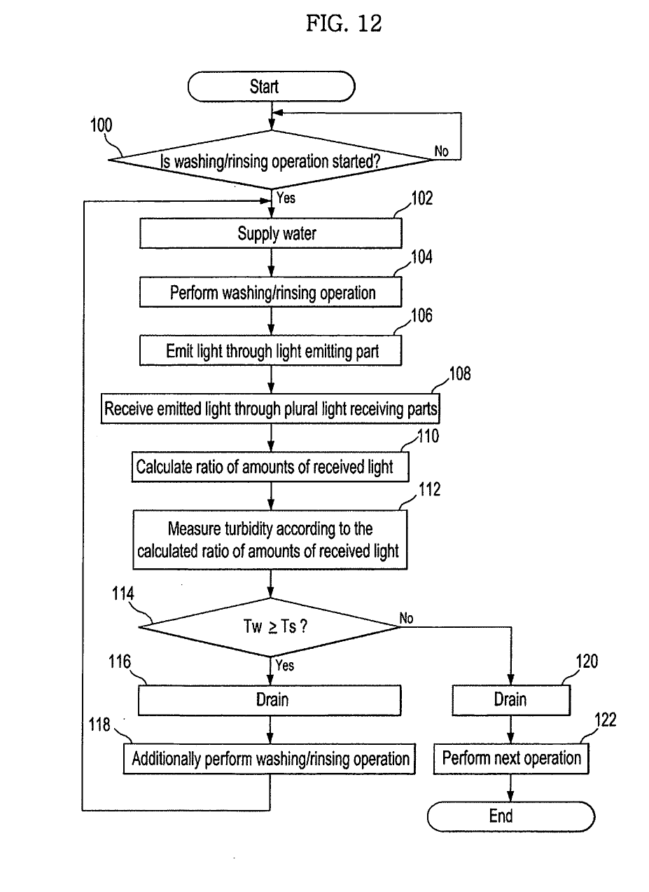

FIG. 12 is a flow chart illustrating a method of measuring turbidity in the dishwasher, in which the turbidity sensor in accordance with the first embodiment is installed.

The appliance control unit 66 determines whether or not a washing/rinsing operation is started under the condition that dishes to be washed are put in the washing tub 62 (100), and supplies water required to perform the washing/rinsing operation to the inside of the washing tub 62 through the driving unit 68, when it is determined that the washing/rinsing operation is started (102).

The water supplied to the inside of the washing tub 62 flows into the sump 64 provided under the washing tub 62, and then is sprayed onto the dishes in the washing tub 64 to perform the washing/rinsing operation (104).

When the washing/rinsing operation is performed, contaminants stuck to the dishes as well as the water are washed and supplied to the sump 64. Thus, when the light emitting part 41 of the turbidity sensor 40 installed in the sump 64 emits light at a regular intensity to measure the turbidity of the water (106), the first receiving part 42 receives light, which passes through water in the sump 64 and travels straight, and the second receiving part 43 receives light, which is scattered by particles contained in the water (108).

Thereafter, the sensor control unit 45 measures the turbidity (Tw) of the water by calculating a ratio of the amounts of light respectively received by the first and second light receiving parts 42 and 43 (110), and transmits the measured turbidity (Tw) to the appliance control unit 66 (112).

Then, the appliance control unit 66 compares the turbidity (Tw) of the water measured by the sensor control unit 45 of the turbidity sensor 40 with a reference turbidity (Ts) (114). When the measured turbidity (Tw) is greater than or equal to the reference turbidity (Ts), the water in the washing tub 64 is drained (116), and then the method is fed back to the step 102 to additionally perform the washing/rinsing operation (118).

As the comparison result of the step 114, when the measured turbidity (Tw) is not more than or equal to the reference turbidity (Ts), it is determined that the washing/rinsing operation is completed and the water in the washing tub 64 is drained (120), and then a next operation is performed (122).

Although FIGS. 8 to 10 illustrate the examples of the installation of the turbidity sensor of the present embodiment in the washing machine 50 and the dishwasher 60, the turbidity sensor of the present embodiment is not limited thereto but may be applied to any electric home appliances using water, such as a water purifier. In addition, while FIGS. 8 to 10 illustrate the installation of the turbidity sensor of the first embodiment, it is understood that FIGS. 8 to 10 may also illustrate the installation of the turbidity sensor of the second embodiment.

As apparent from the above description, the present embodiments provide a turbidity sensor, which correctly senses the turbidity of water although the surface of the turbidity sensor is covered with foreign substances, such as scale, due to use for a long time to prevent the malfunction of the sensor due to the scale, and an electric home appliance having the turbidity sensor.

The turbidity sensor of the present embodiments and the electric home appliance having the same correctly measure the turbidity of water under any change in circumstances in addition to scale. For example, the amounts of light received by a plurality of light receiving parts are reduced to the same percentage under the power supply fluctuation of a light emitting part or the aging of an LED forming the light emitting part, and the ratio of the amounts of light is uniformly maintained at any time and thus the turbidity sensor correctly measures the turbidity of water.

Although embodiments have been shown and described, it would be appreciated by those skilled in the art that changes may be made in these embodiments without departing from the principles and spirit of the invention, the scope of which is defined in the claims and their equivalents.

What is claimed is:

1. A turbidity sensor, comprising:
a light emitting part emitting light;
a plurality of light receiving parts receiving the light emitted from the light emitting part; and
a control unit determining a turbidity of water according to a ratio of amounts of the light received by the plurality of light receiving parts.

2. The turbidity sensor according to claim 1, wherein the plurality of light receiving parts include a first light receiving part receiving light emitted from the light emitting part and travelling straight, and a second light receiving part receiving light emitted from the light emitting part and scattered.

3. The turbidity sensor according to claim 2, wherein the first light receiving part is installed in a direction of directly receiving the light emitted from the light emitting part, and the second light receiving part is installed in another direction of not directly receiving the light emitted from the light emitting part.

4. The turbidity sensor according to claim 3, wherein the second light receiving part is installed at a position below the light emitting part and the first light receiving part in a direction approximately perpendicular to a straight line connecting the light emitting part and the first light receiving part.

5. The turbidity sensor according to claim 2, wherein the ratio of the amounts of the light is a ratio of an amount of light received by the second light receiving part to an amount of light received by the first light receiving part.

6. The turbidity sensor according to claim 5, wherein the ratio of the amounts of the light is increased in accordance with an increased level of turbidity of the water.

7. The turbidity sensor according to claim 2, wherein the plurality of light receiving parts includes a first light receiving part receiving light emitted from the light emitting part and travelling straight, and a plurality of second light receiving parts receiving light emitted from the light emitting part and scattered.

8. The turbidity sensor according to claim 7, wherein the ratio of the amounts of the light is an average of a ratio of an amount of light received by any one of the plurality of second light receiving parts to an amount of light received by the first light receiving part and a ratio of an amount of light received by another of the plurality of second light receiving parts to the amount of light received by the first light receiving part.

9. The turbidity sensor according to claim 7, wherein the ratio of the amounts of the light is a ratio of a sum of amounts of light received by the plurality of second light receiving parts to an amount of light received by the first light receiving part.

10. A turbidity sensor, comprising:
a substrate having a light emitting part, a first light receiving part receiving light emitted from the light emitting part and travelling straight, and a second light receiving part receiving light emitted from the light emitting part and scattered; and
a control unit determining a turbidity of water according to a ratio of amounts of light received by the first and second light receiving parts installed on the substrate.

11. The turbidity sensor according to claim 10, wherein the second light receiving part is installed halfway between the light emitting part and the first light receiving part.

12. The turbidity sensor according to claim 10, further comprising a cover covering the light emitting part and the first and second light receiving parts to prevent the light emitting part and the first and second light receiving parts from directly contacting water.

13. A turbidity sensor used in an electric home appliance having a control unit controlling an operation of the appliance using a turbidity of water, comprising:
a light emitting part emitting light;
a plurality of light receiving parts receiving the light emitted from the light emitting part; and
a circuit transmitting output values of amounts of light respectively received by the plurality of light receiving parts to the electric home appliance to determine the turbidity of the water according to a ratio of the amounts of light respectively received by the plurality of light receiving parts.

14. The turbidity sensor according to claim 13, wherein the plurality of light receiving parts includes a first light receiving part receiving light emitted from the light emitting part and travelling straight, and a second light receiving part receiving light emitted from the light emitting part and scattered.

15. The turbidity sensor according to claim 14, wherein the first light receiving part is installed in a direction of directly receiving the light emitted from the light emitting part, and the second light receiving part is installed in another direction of not directly receiving the light emitted from the light emitting part.

16. The turbidity sensor according to claim 14, wherein the plurality of light receiving parts includes a first light receiving part receiving light emitted from the light emitting part and travelling straight, and a plurality of second light receiving parts receiving light emitted from the light emitting part and scattered.

17. An electric home appliance, comprising:
a container configured to receive water;
a turbidity sensor installed in the container and including a light emitting part emitting light, a plurality of light receiving parts receiving the light emitted from the light emitting part, and a control unit of the turbidity sensor determining turbidity of the water according to a ratio of amounts of light received by the light receiving parts and transmitting the turbidity of the water; and
a control unit of the electric home appliance receiving the transmitted turbidity of the water from the control unit of the turbidity sensor and controlling an operation of the appliance according to the turbidity of the water.

18. The electric home appliance according to claim 17, wherein the plurality of light receiving parts includes a first light receiving part receiving light emitted from the light emitting part and travelling straight, and at least one second light receiving part receiving light emitted from the light emitting part and scattered.

19. The electric home appliance according to claim 18, wherein the first light receiving part is installed in a direction of directly receiving the light emitted from the light emitting part, and the at least one second light receiving part is installed in another direction of not directly receiving the light emitted from the light emitting part.

20. The electric home appliance according to claim 18, wherein the at least one second light receiving part is provided in plural numbers.

21. The electric home appliance according to claim 17, wherein the electric home appliance includes a washing machine, a dishwasher, or a water purifier.

22. An electric home appliance, comprising:
a container configured to receive water;
a turbidity sensor installed in the container and including a light emitting part emitting light, a plurality of light receiving parts receiving the light emitted from the light emitting part, and a circuit transmitting the amounts of light respectively received by the plurality of light receiving parts; and
a control unit determining turbidity of the water according to a ratio of the amounts of light respectively received by the light receiving parts and transmitted from the turbidity sensor, and controlling an operation of the appliance using the received turbidity of the water.
